(19) United States
(12) Patent Application Publication
(10) Pub. No.: US 2016/0181615 A1
(43) Pub. Date: Jun. 23, 2016

(54) Solid-State Batteries with Improved Performance and Reduced Manufacturing Costs and Methods for Forming the Same

(71) Applicant: Intermolecular, Inc., San Jose, CA (US)

(72) Inventors: Jeroen Van Duren, Palo Alto, CA (US); Abraham Anapolsky, San Mateo, CA (US)

(21) Appl. No.: 14/577,774

(22) Filed: Dec. 19, 2014

(51) Int. Cl. H01M 4/62; H01M 10/052; H01M 4/04; H01M 4/66

(52) U.S. Cl. CPC H01M 4/621; H01M 4/662; H01M 10/052; H01M 4/04; H01M 2220/30

(57) ABSTRACT

Embodiments provided herein describe solid-state lithium batteries and methods for forming such batteries. A layer stack may be formed between a substrate of the batteries and a current collector of the batteries. A texturing may be provided to at least one of the components of the batteries to increase the interfacial area between the components. At least one of conductive metal oxides, conductive metal nitrides, conductive metal carbides, or a combination thereof may be used to form a current collector of the batteries.

The present invention relates to solid-state batteries. More particularly, this invention relates to solid-state lithium batteries with electrodes that are infused with an ionically-conductive material and methods for forming such batteries.

### BACKGROUND

In an attempt to be more energy efficient as a society, and accommodate more mobile applications, there is a need for improved power sources, such as batteries. Generally, it is desirable to develop safer batteries (e.g., without any flammable liquid) with higher energy densities, longer cycle life, reduced self-discharge, higher power capability, faster charge/discharge rates, wider operating temperature ranges, and lower manufacturing costs. Ideally, these batteries would also be very small (e.g., thin form factor and be scalable to micron-size) and would be capable of being easily integrated with modern printed circuit boards and integrated circuits.

One possible solution for these batteries is solid-state lithium batteries. However, current implementations of solid-state batteries suffer from low manufacturing yield, high manufacturing costs, and low energy density.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional view of a substrate with a first adhesion layer formed above.

FIG. 2 is a cross-sectional view of the substrate of FIG. 1 with a diffusion barrier layer formed above the first adhesion layer.

FIG. 3 is a cross-sectional view of the substrate of FIG. 2 with a second adhesion layer formed above the diffusion barrier layer.

FIG. 4 is a cross-sectional view of the substrate of FIG. 3 with a current collector formed above the second adhesion layer.

FIG. 5 is a cross-sectional view of a first component with a second component formed above.

FIG. 6 is a cross-sectional view of the first and second components of FIG. 5 illustrating a texturing process being performed on the second component.

FIG. 7 is a cross-sectional view of the first and second components of FIG. 6 after completion of the texturing process.

FIG. 8 is a cross-sectional side view of a solid-state battery according to some embodiments.

FIG. 9 is a flow chart illustrating a method for forming a solid-state battery according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims, and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

In some embodiments, methods are provided for forming solid-state batteries in such a way as to improve performance and/or reduce manufacturing costs. In some embodiments, in order to, for example, increase throughput (i.e., reduce manufacturing time/costs) and increase energy density, the solid-state battery is formed on a thin, conductive substrate, such as aluminum, copper, steel (carbon or stainless), or a cladded foil. A layer stack is formed between the substrate and the cathode current collector. The layer stack includes a diffusion barrier layer and perhaps at least one adhesion layer. The diffusion barrier layer may be made of chromium, molybdenum, a conductive metal nitride, a conductive metal oxynitride, and/or a conductive metal oxide. The adhesion layer may be made of titanium or chromium. In some embodiments, two adhesion layers are included, on opposing sides of the diffusion barrier layer. The cathode current collector may be formed on the upper most layer of the stack.

In some embodiments, in order to, for example, increase the interfacial area between the various components/layers of the battery (e.g., to increase external cell capacity and energy density, as well as provide stress relief to prevent adhesion failure and delamination, at least one of the components/layers (e.g., the substrate and/or any of the layers) is provided with a surface roughness (or topographical roughening). The surface roughness may be provided by performing an etching process (e.g., wet or dry) to the substrate (e.g., metal foil or ceramic) before the other components/layers are formed, or by etching one of the functional layers after it is deposited (e.g., the cathode current collector). In some embodiments, the surface roughness is introduced by including an additional layer in the device, such as a transparent conductive oxide, which may then be etched. In some embodiments, the surface roughness is created by forming one of the layers with particles of various size dispersed therein (e.g., a sol-gel formulation). The surface roughness may also be created on the substrate by forming the substrate via casting/firing (e.g., ceramic substrates, such as aluminum oxide), for example, by stamping or laser ablating the substrate after it is formed or by casting the substrate on a textured surface.

In some embodiments, in order to, for example, reduce manufacturing costs, the cathode current collector is made of a material that is less expensive than the materials typically used (e.g., gold or platinum). General examples include conductive metal oxides, conductive metal nitrides, conductive metal carbides, either crystalline or amorphous. Specific examples include fluorine-doped tin oxide, titanium nitride, tantalum nitride, indium tin oxide, and indium zinc oxide.

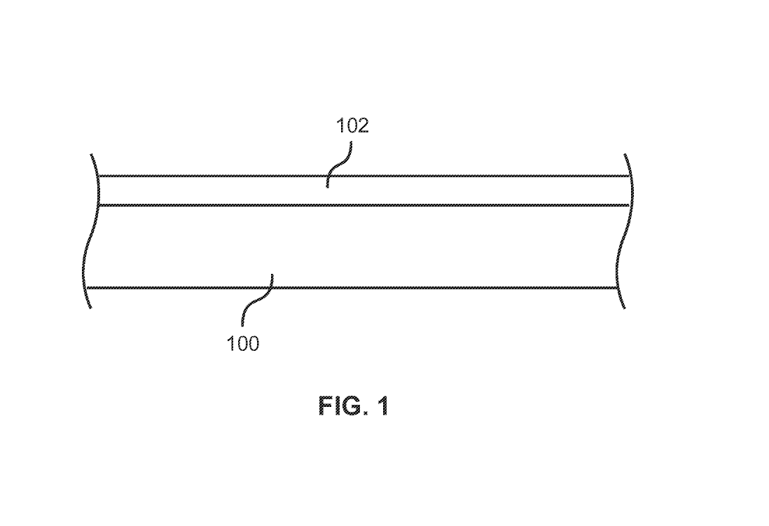

FIGS. 1-5 are cross-sectional views of a substrate, illustrating a method for forming a portion of a solid-state battery, according to some embodiments. Referring to FIG. 1, a substrate 100 is provided. In some embodiments, the substrate 100 includes (or is made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. Other materials that may be used include yttrium-stabilized zirconia and conductive, (amorphous, or crystalline) oxides, such as indium-tin oxide (ITO), aluminum-doped zinc oxide, fluorine-doped tin oxide, and other transparent conductive oxides. In some embodiments, the substrate 100 includes (or is made of) an electrically conductive material. In some embodiments, the substrate 100 is formed on a support or temporary substrate using, for example, a sol-gel process and/or a fire-casting process. The substrate 100 may have a thickness of, for example, between about 5 micrometers (μm) and about 5 millimeters (mm).

Still referring to FIG. 1, a first (or lower) adhesion layer 102 is formed above (e.g., directly on) the substrate 100. In some embodiments, the first adhesion layer 102 includes (or is made of) an electrically conductive material, such as titanium, chromium, or a combination thereof. The first adhesion layer 102 may be formed using any suitable process, such as physical vapor deposition (PVD), and have a thickness of, for example, between about 1 nanometer (nm) and about 50 nm.

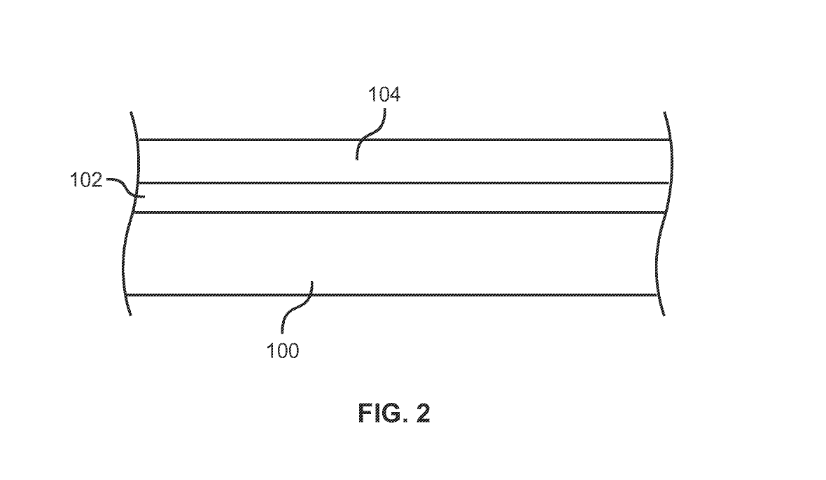

As shown in FIG. 2, a diffusion barrier layer (or simply a “barrier layer”) 104 is formed above (e.g., directly on) the first adhesion layer 102. In some embodiments, the barrier layer 104 includes (or is made of) an electrically conductive material and has a thickness of, for example, between about 100 nm and about 1000 nm. In some embodiments, the barrier layer 104 includes tantalum, titanium, chromium, molybdenum, zinc, tin, cadmium, or a combination thereof. Suitable examples include, but are not limited to, chromium (e.g., with a thickness of about 500 nm), refractory metals, such as molybdenum (e.g., about 1000 nm), conductive metal nitrides, such as tantalum nitride or titanium nitride (e.g., about 100 nm), conductive metal oxynitrides, such as titanium oxynitride (e.g., about 100 nm), and conductive metal oxides, such as doped zinc oxide, doped tin oxide, doped cadmium oxide. It should be noted that any combination of these materials, or sub-layers thereof, may be used to form the barrier layer 104.

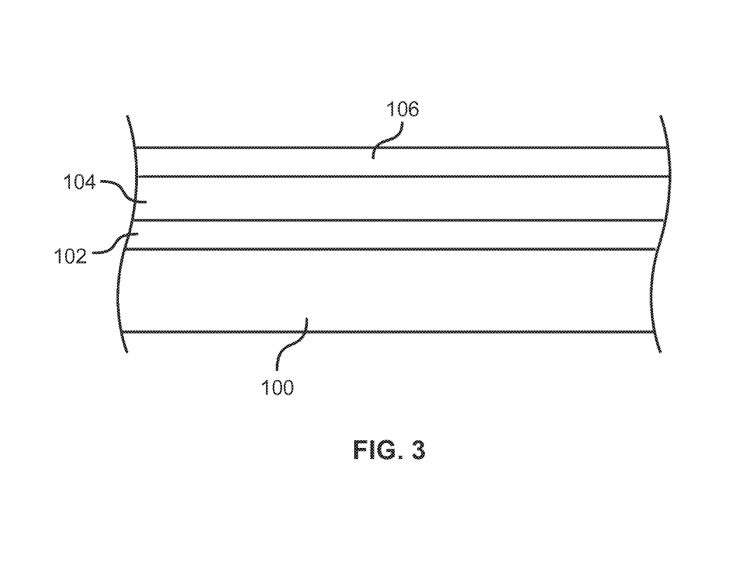

Referring now to FIG. 3, a second (or upper) adhesion layer 106 is then formed above (e.g., directly on) the barrier layer 104. In some embodiments, the second adhesion layer 106 is similar as the first adhesion layer 102 (e.g., made of the same material(s), has the same thickness, formed using the same process, etc.). Although the depicted embodiment includes two adhesion layers 102 and 106, it should be understood that in some embodiments only one adhesion layer (102 or 106) is included, while in some embodiments, no adhesion layer is included at all. It should also be noted that in at least some embodiments the adhesion layers 102 and/or 106 are made of a material that is different than that of the barrier layer 104.

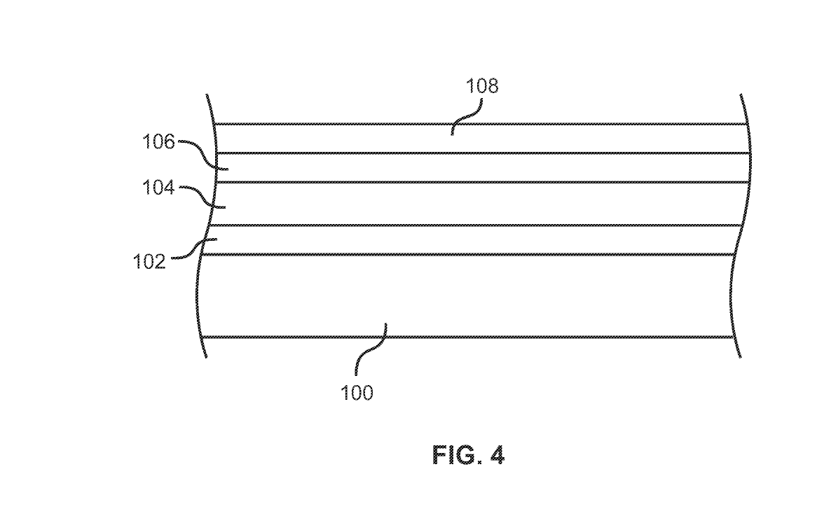

As shown in FIG. 4, a current collector (e.g., a cathode current collector) 108 is then formed above (e.g., directly on) the second adhesion layer 106. In some embodiments, the current collector 108 includes (or is made of) an electrically conductive material. In some embodiments, the current collector 108 includes a noble metal, such as gold, platinum, cobalt, palladium, or a combination thereof. In some embodiments, the current collector 108 includes a layer of cobalt and a thinner layer of gold formed over the cobalt. In some embodiments, the current collector 108 includes a relatively low-cost material (e.g., less expensive than gold) such as a conductive metal oxide, a conductive metal nitride, a conductive metal carbide, either crystalline or amorphous, or a combination thereof. Examples include fluorine-doped tin oxide, titanium nitride, tantalum nitride, ITO, and indium zinc oxide. The current collector 108 may have a thickness of, for example, between about 100 nm and about 300 nm. The current collector 108 may be formed using any suitable process, such as physical vapor deposition (PVD) (e.g., sputtering), chemical vapor deposition (CVD), or plating.

Thus, FIGS. 1-4 illustrate the formation of a current collector 108 above a substrate 100, with a layer stack (e.g., the adhesion layers 102 and 106 and the barrier layer 104) formed between. As described below, other components (e.g., a cathode, an electrolyte layer, etc.) may then be formed above the current collector 108 to complete the formation of a solid-state battery, as is described in greater detail below.

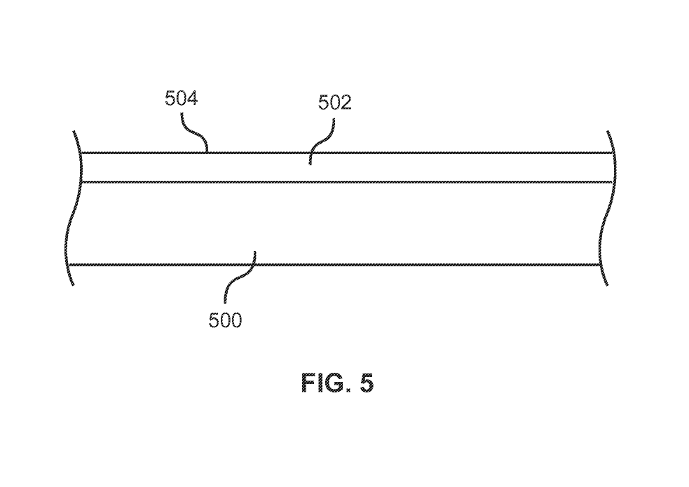

FIGS. 5-7 illustrate a method for forming textured, or “roughened,” components for use in, for example, a solid-state battery. Referring to FIG. 5, a first component (or layer) 500 is provided. The first component 500 may correspond to any component or layer of a solid-state battery, such as the substrate (e.g., substrate 100) or any layer within a solid-state battery (e.g., the current collector 108). Alternatively, the first component 500 may correspond to a temporary, or sacrificial, support on which a substrate (e.g., substrate 100) is formed, such as when the substrate 100 is formed using a sol-gel and/or fire-casting process.

Still referring to FIG. 5, a second component (or layer) 502 is formed above the first component 500. In a manner similar to the first component 500, the second component 502 may correspond to any component or layer of a solid-state battery, such as the substrate (e.g., substrate 100) or any layer within a solid-state battery (e.g., the current collector 108, a cathode, etc.). However, in some embodiments, the second component 502 is an additional layer (e.g., a layer that is not conventionally present) in the solid-state battery, which is used solely to provide a textured surface. In such embodiments, the second component 502 may be made of, for example, a transparent conductive oxide, such as ITO. The second component may be formed using any process (e.g., PVD, CVD, plating, etc.). As shown in FIG. 5, in some embodiments, the second component 502 may initially have a smooth, flat upper surface 504.

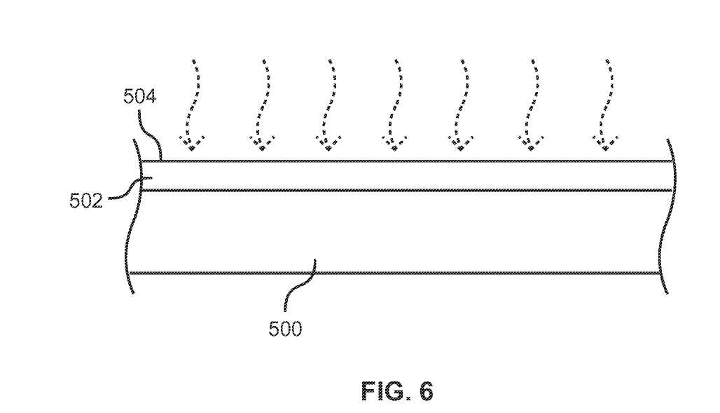

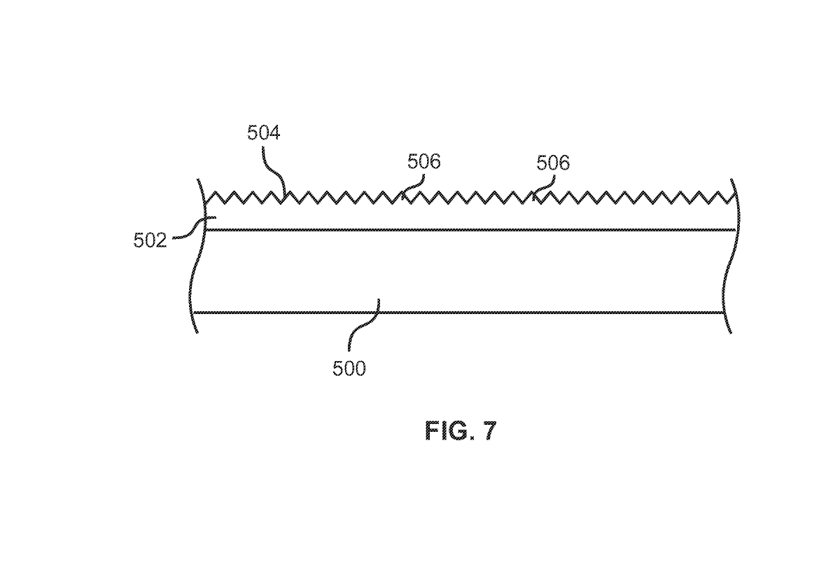

Referring now to FIG. 6, in some embodiments, the second component 502 then undergoes a texturing process. In some embodiments, the texturing is performed using an etching process (e.g., wet or dry), stamping, laser ablation, or a combination thereof. As shown in FIG. 7, due to the texturing process, a series of texture, or roughness, formations 506 manifest on the upper surface 504 of the second component 502. In some embodiments, after the texturing process, a heating or thermal process may be performed on the second component (and/or the device as a whole).

However, it should be understood that in some embodiments, the second component 502 is formed in such a way that the texture formations 506 are present on the upper surface 504 thereof (i.e., no additional texturing process is required). For example, in some embodiments, the second component 502 is made of a transparent conductive oxide and is formed using a CVD process. As will be appreciated by one skilled in the art, the CVD process may be controlled such that the transparent conductive oxide is deposited in a textured manner. As another example, in some embodiments, the upper surface of the first component 500 is textured, or patterned, such that the upper surface 504 of the second component 502 is contoured or textured in a similar manner. Such a method may be used, for example, in some embodiments in which the second component 502 is a substrate (e.g., substrate 100) which is formed using a sol-gel and/or fire-casting process (e.g., made of a ceramic material, such as aluminum oxide). As a further example, in some embodiments in which the second component 502 is formed using a sol-gel process, the formulation used may include particles of various sizes, which results in the upper surface 504 being textured.

Thus, FIGS. 5-7 illustrate the formation of any component/layer of a solid-state battery in such a way to create a textured or roughened surface over which additional components/layers (e.g., a cathode, an electrolyte layer, etc.) may then be formed to complete the formation of a solid-state battery, as is described in greater detail below.

It should be understood that the method(s) depicted in FIGS. 5-7 may be used in combination with the method(s) depicted in FIGS. 1-4. Alternatively, the method(s) depicted in FIGS. 5-7 may be used in the formation of the solid-state battery independent of those depicted in FIGS. 1-4, and vice versa.

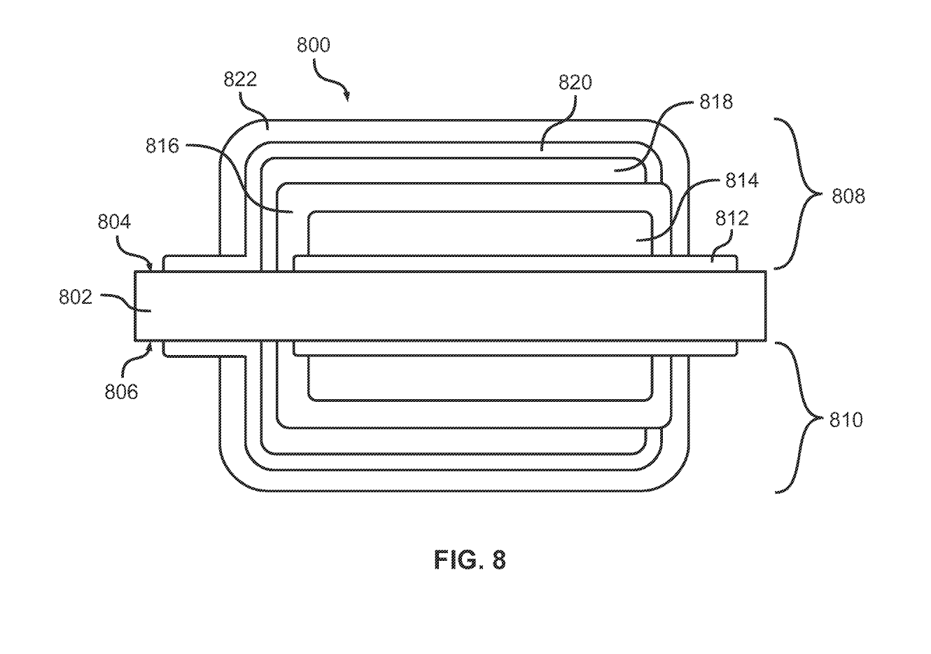

FIG. 8 illustrates a solid-state lithium battery (or battery cell) 800, according to some embodiments. The battery 800 includes a substrate 802 having a first side 804 and a second side 806. In some embodiments, the substrate 802 is similar to the substrate 100 (FIGS. 1-4), and may be made of the material(s) described above. The substrate may have a thickness of, for example, between about 5 μm and about 5 mm.

The embodiment shown in FIG. 8 is in a “double-sided” configuration. Thus, the battery 800 includes a first battery stack 808 formed on the first side 804 of the substrate 802 and a second battery stack 810 formed on the second side 806 of the substrate 802. In some double-sided embodiments, the first and second battery stacks 808 and 810 are identical, or substantially identical. Thus, for the purposes of this description, although only the first battery stack 808 is described in detail, it should be understood that the second battery stack 810 may be identical. In other embodiments, a “single-sided” configuration is used in which a battery stack is only formed on one side of the substrate 802, and a protective coating (e.g., silicon nitride, tantalum nitride, titanium nitride, etc.) may be formed on the other side of the substrate 802.

Still referring to FIG. 8, the first battery stack 808 includes a cathode (or first) current collector 812, a cathode (or first electrode) 814, an electrolyte 816, an anode (or second electrode) 818, an anode (or second) current collector 820, and a protective layer 822.

The various layers (or components) in the battery stack 808 may be formed sequentially (i.e., from bottom to top) above the substrate 802 using, for example, PVD and/or reactive sputtering processing, or any other processes (e.g., plating, sol-gel processes, etc.) that are suitable depending on the material(s), thicknesses, etc. Although the components may be described as being formed “above” the previous component (or the substrate), it should be understood that in some embodiments, each layer is formed directly on (and adjacent to) the previously provided/formed component. In some embodiments, additional components (or layers) may be included between the components shown in FIG. 8 (as well as those shown in FIGS. 1-7), and other processing steps may also be performed between the formation of various components, such as those described in FIG. 1-7, either separately, or in combination.

Still referring to FIG. 8, the cathode current collector 812 is formed above the substrate 802 (e.g., above the first side 804 of the substrate 802), and may be similar to the current collector 108 described above. Thus, in some embodiments, the cathode current collector 812 includes (or is made of) a noble metal, such as gold, platinum, or a combination thereof. In some embodiments, the cathode current collector 812 includes a conductive metal oxide, a conductive metal nitride, a conductive metal carbide, either crystalline or amorphous, or a combination thereof (e.g., fluorine-doped tin oxide, titanium nitride, tantalum nitride, ITO, and indium-zinc oxide). The cathode current collector 812 may have a thickness of, for example, between about 100 nm and about 300 nm. As shown in FIG. 8, the cathode current collector 812 may be selectively formed on the substrate 802 such that it does not cover some portions of the substrate 802.

The cathode (or first electrode) 814 is formed above the cathode current collector 812. In some embodiments, the cathode 814 includes lithium and cobalt (e.g., lithium-cobalt oxide) and has a thickness of, for example, greater than about 4 μm (e.g., even greater than 10 μm), such as between about 5 μm and about 15 μm. The cathode 814 may be formed using, for example, PVD (e.g., sputtering), a sol-gel process, screen printing, tape casting, electrophoretic deposition, or any other suitable method. In the embodiment shown in FIG. 8, the cathode 814 is selectively formed above the cathode current collector 812 such that no portion of it is in direct contact with the substrate 802. Although not shown, in some embodiments, a thin (e.g., 1-3 nm) adhesion layer may be formed between the cathode current collector 812 and the cathode 814 and/or between the anode 818 and the anode current collector 820.

After the material of the cathode 814 is deposited, a sintering process may be performed, for example, to increase the density of the material. This annealing may also be required in order to adjust the crystallographic orientation of the material of the cathode for optimal performance. The heating process may be performed in the same processing chamber in which the cathode 814 (and perhaps other components of the battery 800) is formed (i.e., “in situ”). Alternatively, the heating process may be performed in a different processing chamber than that used to form the cathode 814 (i.e., “ex situ”). In some embodiments, the cathode 814 is heated to a temperature of, for example, greater than about 600° C. (e.g., between about 600° C. and about 800° C.) during the heating process. The heating process may be performed in a gaseous environment including sources of oxygen, nitrogen, argon, and/or hydrogen (e.g., 80% nitrogen, 20% oxygen, air/atmosphere, etc.) with either ambient humidity, or no humidity. In some embodiments, the heating process is performed for a duration of, for example, greater than 30 minutes (e.g., 30-60 minutes). The heating process may utilize a temperature ramp rate of, for example, between about 5° C. and about 10° C. per minute (e.g., starting from room temperature).

As shown in FIG. 8, the electrolyte 816 is formed above the cathode 814. In some embodiments, the electrolyte 816 includes, or is made of, lithium-phosphorous oxynitride (i.e., LiPON). The LiPON may be a “solid” electrolyte (i.e., an electrolyte that does not have a liquid component) formed using PVD, such as a sputtering process, such that the battery 800 is an “all solid-state” lithium battery. In some embodiments, the electrolyte 816 has a thickness of, for example, between about 1 μm and about 2 μm. As shown, in the depicted embodiment, the electrolyte 816 is formed such that it covers the ends (and/or sides) of the cathode 814. The electrolyte 816 may prevent contact between the cathode 814 and the anode 818 and be conductive to ions, while being resistive to electrons.

The anode (or second electrode) 818 is formed above the electrolyte 816. In some embodiments, the anode 818 includes (or is made of) lithium metal, and perhaps silicon, and/or carbon as well. The anode 818 may have a thickness of, for example, between 1.0 μm and 5.0 μm. In the depicted embodiment, the anode 818 is formed such that it covers an end of the electrolyte 816 opposite an exposed end of the cathode current collector 812.

The anode (or second) current collector 820 is formed above the anode 818. In some embodiments, the anode current collector 820 includes (or is made of) a conductive material that is thermodynamically and (electro-)chemically stable with the material (e.g., lithium metal) of the anode 818. Suitable materials include scandium, titanium, vanadium, chromium, manganese, iron, cobalt, nickel, copper, yttrium, zirconium, lanthanum, hafnium, molybdenum, tantalum, tungsten, titanium nitride, or a combination thereof (e.g., a bi-layer, tri-layer, multi-layer, sandwich, composite or alloy). The anode current collector 820 may have a thickness of, for example, between about 0.1 μm and about 3 μm. In the depicted embodiment, the anode current collector 820 is formed such that it covers both ends of the anode 818 and a portion thereof is formed directly on an exposed portion of the substrate 802. It should be noted that in some embodiments the anode current collector 820 may not be formed above the anode 818. In some embodiments, the anode current collector 820 may be formed above the substrate 802 and be partially covered by (and in contact with) the anode 818, but not the cathode 814 or the cathode current collector 812.

The protective layer 822 is formed over the anode current collector 820. In some embodiments, the protective layer 822 includes (or is made of) a nitride, such as aluminum nitride or silicon nitride. In some embodiments, the protective layer 822 includes parylene (e.g., as a single layer, or part of an alternating multi-layer stack also including, for example, a nitride, oxide, or oxynitride). The protective layer 822 may have a thickness of, for example, between about 1 μm and about 30 μm. As is shown in FIG. 8, the protective layer 822 may be formed to leave portions of the cathode current collector 812 and the anode current collector 820 exposed to form electrical connections to the battery 800.

During operation of the battery 800, when the battery 800 is allowed to discharge, lithium ions (i.e., Li⁺) migrate from the anode 818 to the cathode 814 by diffusing through the electrolyte 816. When the anode and cathode reactions are reversible, as for an intercalation compound or alloy, such as lithium-cobalt oxide, the battery 800 may be recharged by reversing the current. The difference in the electrochemical potential of the lithium determines the cell voltage. Electrical connections are made to the battery 800, for both discharging and charging, through the current collectors 812 and 820.

In some embodiments, the use of the layer stack between the substrate and the current collector (e.g., the cathode current collector) described above may prevent diffusion of material (e.g., iron and nickel) from the substrate (e.g., electrically conductive substrates) into the active components of the battery (e.g., the cathode), while also preventing diffusion of material (e.g., lithium and cobalt) from the active components into the substrate, particularly during the annealing of the cathode. As a result, the capacity, voltage, and cycle life of the batteries may be improved.

In some embodiments, the texturing of the surfaces between the components of the battery increases the interfacial area between the components. As a result, the capacity, energy density, and power of the batteries may be increased in a low-cost manner, using conventional solid-state battery materials. Additionally, the texturing may provide stress relief to prevent adhesion failure and/or delamination, particularly when relatively thick layers are used, which may allow wider manufacturing process windows to be used and lead to longer battery life. The texturing may also improve the battery with respect to adhesion between components/layers, nucleation, ion or electron conductivity (impedance/resistance) across the interfaces, durability, cyclability, as well as remove contaminants. In some embodiments, the manufacturing costs of the batteries may be reduced due to the use of relatively inexpensive materials in the cathode current collector (e.g., conductive metal oxides, conductive metal nitrides, conductive metal carbides, etc.).

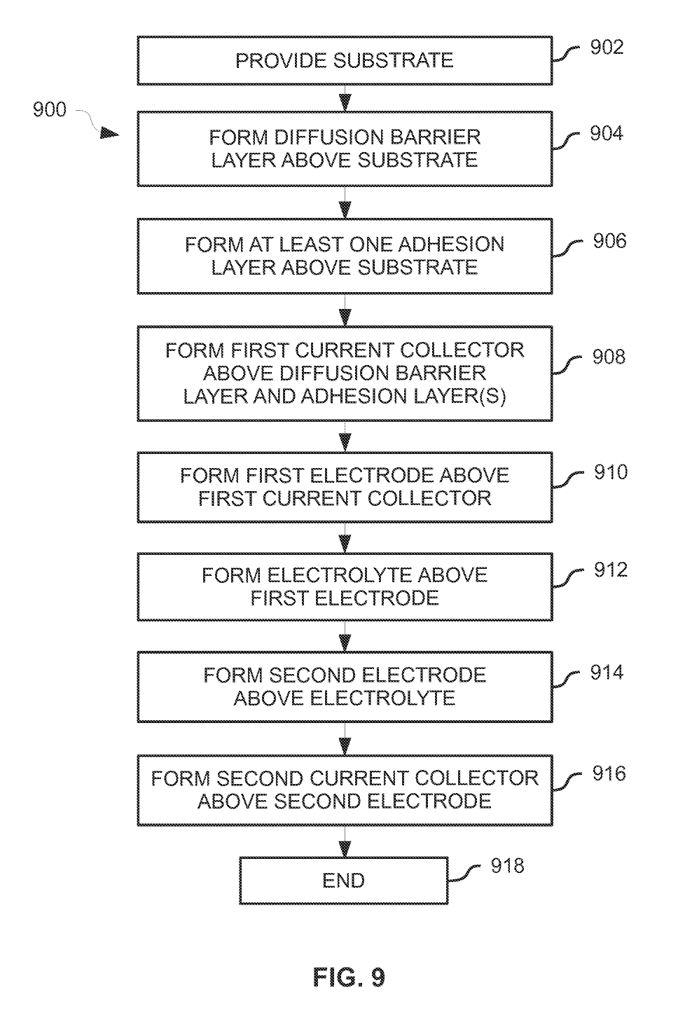

FIG. 9 illustrates a method 900 for forming a solid-state lithium battery according to some embodiments. At block 902, a substrate, such as those describe above, is provided. In some embodiments, the substrate includes (or is made of) aluminum oxide (e.g., alumina), silicon oxide (e.g., silica), zirconium oxide (e.g., zirconia), aluminum nitride, a semiconductor material, such as silicon and/or germanium, a metal foil (e.g., aluminum, titanium, stainless steel, etc.), and/or a polymer or plastic. Other materials that may be used include yttrium-stabilized zirconia and conductive, (amorphous or crystalline) oxides, such as indium-tin oxide (ITO), aluminum-doped zinc oxide, fluorine-doped tin oxide, and other transparent conductive oxides. In some embodiments, the substrate includes (or is made of) an electrically conductive material.

At block 904, a diffusion barrier layer is formed above the substrate. In some embodiments, the diffusion barrier layer includes an electrically conductive material and has a thickness of, for example, between about 100 nm and about 1000 nm. In some embodiments, the diffusion barrier layer includes tantalum, titanium, chromium, molybdenum, zinc, tin, cadmium, or a combination thereof. Other suitable examples include conductive metal nitrides, such as tantalum nitride or titanium nitride, conductive metal oxynitrides, such as titanium oxynitride, and conductive metal oxides, such as doped zinc oxide, doped tin oxide, doped cadmium oxide.

At block 906, at least one adhesion layer is formed above the substrate. In some embodiments, one adhesion layer is formed between the substrate and the diffusion barrier layer, and another adhesion layer is formed above the diffusion barrier layer. The adhesion layer(s) may be made of an electrically conductive material, such as titanium, chromium, or a combination thereof and have a thickness of, for example, between about 1 nm and about 50 nm.

At block 908, a first current collector is formed above the diffusion barrier layer and the adhesion layer(s). In some embodiments, the first current collector includes an electrically conductive material. In some embodiments, the first current collector includes a noble metal, such as gold, platinum, cobalt, palladium, or a combination thereof. In some embodiments, the current collector includes a relatively low-cost material, such as a conductive metal oxide, a conductive metal nitride, a conductive metal carbide, or a combination thereof. Examples include fluorine-doped tin oxide, titanium nitride, tantalum nitride, ITO, and indium zinc oxide. The first current collector may have a thickness of, for example, between about 100 nm and about 300 nm.

At block 910, a first electrode (e.g., a cathode) is formed above the first current collector. In some embodiments, the first electrode includes lithium and cobalt (e.g., lithium-cobalt oxide) and has a thickness of, for example, between about 5 μm and about 15 μm, such as about 10 μm (or more).

At block 912, an electrolyte is formed above the first electrode. The electrolyte may be a solid electrolyte formed, or deposited, using a PVD process. In some embodiments, the electrolyte includes LiPON and has a thickness of, for example, between about 1 μm and about 2 μm. At block 914, a second electrode (e.g., an anode) is formed above the electrolyte. The second electrode may include lithium metal and have a thickness of, for example, between 1 μm and 5 μm.

At block 916, a second current collector (e.g., an anode current collector) is formed above the second electrode. In some embodiments, the second current collector includes scandium, titanium, vanadium, chromium, manganese, iron, cobalt, nickel, copper, yttrium, zirconium, lanthanum, hafnium, molybdenum, tantalum, tungsten, titanium nitride, or a combination thereof. The second current collector may have a thickness of, for example, between about 0.1 μm and about 3+ μm.

Although not shown in FIG. 9, in some embodiments, at least one of the layers/components of the battery may be provided with a textured surface, as described above. Additionally, in some embodiments, a protective layer (e.g., a nitride) may be formed above the second current collector. Additionally, in some embodiments, two sets of the components of the battery are formed on opposing sides of the substrate (i.e., a double-sided configuration), while in other embodiments, the components are only formed on one side of the substrate (i.e., a single-sided configuration). At block 918, the method 900 ends.

Thus, in some embodiments, methods for forming a solid-state battery are provided. A substrate is provided. A diffusion barrier layer is formed above the substrate. The diffusion barrier layer includes at least one of tantalum, titanium, chromium, molybdenum, zinc, tin, cadmium, or a combination thereof. At least one adhesion layer is formed above the substrate. The at least one adhesion layer is made of a material different than that of the diffusion barrier layer and includes at least one of titanium, chromium, or a combination thereof. A first current collector is formed above the diffusion barrier layer and the at least one adhesion layer. A first electrode is formed above the first current collector. An electrolyte is formed above the first electrode. A second electrode is formed above the electrolyte. A second current collector is formed above the second electrode.

In some embodiments, methods for forming a solid-state battery are provided. A substrate is provided. The substrate includes an electrically conductive material. A first adhesion layer is formed above the substrate. The first adhesion layer includes at least one of titanium, chromium, or a combination thereof. A diffusion barrier layer is formed above the first adhesion layer. The diffusion barrier layer includes at least one of tantalum, titanium, chromium, molybdenum, zinc, tin, cadmium, or a combination thereof. A second adhesion layer is formed above the diffusion barrier layer. The second adhesion layer includes at least one of titanium, chromium, or a combination thereof. The first adhesion layer and the second adhesion layer are each made of a material different than that of the diffusion barrier layer. A first current collector is formed above the second adhesion layer. A first electrode is formed above the first current collector. An electrolyte is formed above the first electrode. A second electrode is formed above the electrolyte. A second current collector is formed above the second electrode.

In some embodiments, solid-state batteries are provided. The solid-state batteries include a substrate. A diffusion barrier layer is formed above the substrate. The diffusion barrier layer includes at least one of tantalum, titanium, chromium, molybdenum, zinc, tin, cadmium, or a combination thereof. At least one adhesion layer is formed above the substrate. The at least one adhesion layer is made of a material different than that of the diffusion barrier layer and includes at least one of titanium, chromium, or a combination thereof. A first current collector is formed above the diffusion barrier layer and the at least one adhesion layer. A first electrode is formed above the first current collector. An electrolyte is formed above the first electrode. A second electrode is formed above the electrolyte. A second current collector is formed above the second electrode.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a solid-state lithium battery, the method comprising:
providing a substrate;
forming a diffusion barrier layer above the substrate, wherein the diffusion barrier layer comprises at least one of tantalum, titanium, chromium, molybdenum, zinc, tin, cadmium, or a combination thereof;
forming at least one adhesion layer above the substrate, wherein the at least one adhesion layer is made of a material different than that of the diffusion barrier layer and comprises at least one of titanium, chromium, or a combination thereof;
forming a first current collector above the diffusion barrier layer and the at least one adhesion layer;
forming a first electrode above the first current collector;
forming an electrolyte above the first electrode;
forming a second electrode above the electrolyte; and
forming a second current collector above the second electrode.

2. The method of claim 1, wherein the substrate comprises an electrically conductive material.

3. The method of claim 2, wherein the substrate comprises at least one of aluminum, copper, steel, or a cladded foil.

4. The method of claim 3, wherein the diffusion barrier layer has a thickness of between about 100 nanometers (nm) and about 1000 nm.

5. The method of claim 4, wherein the at least one adhesion layer comprises a first adhesion layer and a second adhesion layer, and wherein the diffusion barrier layer is formed above the first adhesion layer, and the second adhesion layer is formed above the diffusion barrier layer.

6. The method of claim 5, wherein each of the first adhesion layer and the second adhesion layer has a thickness of between about 1 nm and about 50 nm.

7. The method of claim 6, wherein the diffusion barrier layer comprises at least one of tantalum nitride, titanium nitride, titanium oxynitride, or a combination thereof, and each of the first adhesion layer and the second adhesion layer comprises titanium.

8. The method of claim 1, further comprising forming a surface roughness on at least one of the substrate, the diffusion barrier layer, the at least one adhesion layer, the first current collector, the first electrode, the electrolyte, the second electrode, or the second current collector.

9. The method of claim 8, wherein the forming of the surface roughness on the at least one of the substrate, the diffusion barrier layer, the at least one adhesion layer, the first current collector, the first electrode, the electrolyte, the second electrode, or the second current collector comprises performing an etching process on at least one of the substrate, the diffusion barrier layer, the at least one adhesion layer, or the first current collector.

10. The method of claim 1, wherein the first current collector comprises at least one of fluorine-doped tin oxide, titanium nitride, tantalum nitride, indium tin oxide, indium zinc oxide, or a combination thereof.

11. A method for forming a solid-state lithium battery, the method comprising:
providing a substrate, wherein the substrate comprises an electrically conductive material;
forming a first adhesion layer above the substrate, wherein the first adhesion layer comprises at least one of titanium, chromium, or a combination thereof;
forming a diffusion barrier layer above the first adhesion layer, wherein the diffusion barrier layer comprises at least one of tantalum, titanium, chromium, molybdenum, zinc, tin, cadmium, or a combination thereof;
forming a second adhesion layer above the diffusion barrier layer, wherein the second adhesion layer comprises at least one of titanium, chromium, or a combination thereof,
wherein the first adhesion layer and the second adhesion layer are each made of a material different than that of the diffusion barrier layer;
forming a first current collector above the second adhesion layer;
forming a first electrode above the first current collector;
forming an electrolyte above the first electrode;
forming a second electrode above the electrolyte; and
forming a second current collector above the second electrode.

12. The method of claim 11, wherein the diffusion barrier layer has a thickness of between about 100 nanometers (nm) and about 1000 nm.

13. The method of claim 12, wherein each of the first adhesion layer and the second adhesion layer has a thickness of between about 1 nm and about 50 nm.

14. The method of claim 13, wherein the first current collector comprises at least one of fluorine-doped tin oxide, titanium nitride, tantalum nitride, indium tin oxide, indium zinc oxide, or a combination thereof.

15. The method of claim 14, further comprising forming a surface roughness on at least one of the substrate, the first adhesion layer, the diffusion barrier layer, the second adhesion layer, the first current collector, the first electrode, the electrolyte, the second electrode, or the second current collector.

16. A solid-state lithium battery comprising:
a substrate;
a diffusion barrier layer formed above the substrate, wherein the diffusion barrier layer comprises at least one of tantalum, titanium, chromium, molybdenum, zinc, tin, cadmium, or a combination thereof;
at least one adhesion layer formed above the substrate, wherein the at least one adhesion layer is made of a material different than that of the diffusion barrier layer and comprises at least one of titanium, chromium, or a combination thereof;
a first current collector formed above the diffusion barrier layer and the at least one adhesion layer;
a first electrode formed above the first current collector;
an electrolyte formed above the first electrode;
a second electrode formed above the electrolyte; and
a second current collector formed above the second electrode.

17. The solid-state battery of claim 16, wherein the substrate comprises an electrically conductive material.

18. The solid-state battery of claim 17, wherein the at least one adhesion layer comprises a first adhesion layer and a second adhesion layer, and wherein the diffusion barrier layer is formed above the first adhesion layer, and the second adhesion layer is formed above the diffusion barrier layer.

19. The solid-state battery of claim 18, wherein the diffusion barrier layer has a thickness of between about 100 nanometers (nm) and about 1000 nm, and wherein each of the first adhesion layer and the second adhesion layer has a thickness of between about 1 nm and about 50 nm.

20. The solid-state battery of claim 19, wherein the first current collector comprises at least one of fluorine-doped tin oxide, titanium nitride, tantalum nitride, indium tin oxide, indium zinc oxide, or a combination thereof.
